(19) United States
(12) Patent Application Publication
(10) Pub. No.: US 2016/0279769 A1
(43) Pub. Date: Sep. 29, 2016

(54) Screwdriver Bit Positioning Structure

(71) Applicant: Yavuz Arslan, Changhua City (TW)

(72) Inventor: Yavuz Arslan, Changhua City (TW)

(21) Appl. No.: 14/667,686

(22) Filed: Mar. 25, 2015

(51) Int. Cl. B25B 23/00

(52) U.S. Cl. CPC B25B 23/0064; B25B 23/0035

(57) ABSTRACT

A screwdriver bit positioning structure includes a connecting rod having a screwdriver bit. A front end of the screwdriver bit is provided with a positioning sleeve. The screwdriver bit is provided with a limit ring and a slide section. The positioning sleeve is a hollow sleeve. One end of the positioning sleeve is provided with a hook portion. Another end of the positioning sleeve is provided with a magnetic member having a through hole. The screwdriver bit is inserted through the positioning sleeve. The hook portion is adapted to engage with the limit ring and slidable on the slide section. The screwdriver bit is exposed out of the positioning sleeve. The positioning sleeve is movable to adjust its position for attracting different sizes of screws and controlling the depth of screwing the screws. The present invention decreases the number of parts, can be assembled easily, and reduces the cost.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a screwdriver bit positioning structure, and more particularly to a screwdriver bit positioning structure which has simple components and can be assembled easily.

2. Description of Related Arts

As shown in FIG. 1 to FIG. 4, a conventional connecting rod is provided with a slide sleeve 13. A front inner hole of the slide sleeve 13 is provided with a magnetic member 18 having a through hole 19. The inner wall of the slide sleeve 13 is formed with a front positioning oblique trough 14 and a rear positioning oblique trough 15 according to the route position of the connecting rod 10. The rear end of the connecting rod 10 is a drive section 11. The front end of the connecting rod 10 is formed with a tool bit connecting hole 101. The connecting rod 10 is formed with a groove 102 to receive a C-shaped elastic member 16 therein. After the slide sleeve 13 is fitted on the connecting rod 10 and moved to the front and rear positioning oblique troughs 14, 15, the C-shaped elastic member 16 is engaged to limit the movement range of the slide sleeve 13. The connecting rod 10 is provided with a recess 121 having a steel ball 17. The slide sleeve 13 is formed with an annular groove 103 to accommodate the steel ball 17. When the slide sleeve 13 is pushed rearward, the C-shaped elastic member 16 is positioned in the front positioning oblique trough 14 and the steel ball 17 is accommodated in the annular groove 13. At this moment, the screwdriver bit 12 can be withdrawn for replacement. Referring to FIG. 2, when the slide sleeve 13 is pushed forward, the C-shaped elastic member 16 is positioned in the rear positioning oblique trough 15. The screwdriver bit 12 can be inserted to the recess 2 with the magnetic member 18 to attract the screw 1 steadily. The aforesaid structure has the following shortcomings:

1. For the slide sleeve 13 to be positioned forward or rearward, it is necessary to lengthen the length of the slide sleeve 13, and the inner wall of the slide sleeve 13 has to be formed with the annular groove 103 and the front and rear positioning oblique troughs 14, 15, and the elastic member 16 and the steel ball 17 are also required. The manufacture cost is increased accordingly.

2. When the C-shaped elastic member 16 of the slide sleeve 13 is located in the rear positioning oblique trough 15, the screwdriver bit 12 extends out of the slide sleeve 13 in a fixed length. When the recess 4 of a big screw 3 is deeper, as shown in FIG. 3, the screwdriver bit 12 is unable to mate with the recess 4 of the big screw 3 totally although the big screw 3 is attracted by the magnetic member 18. When the recess 6 of a small screw 5 is too shallow, as shown in FIG. 4, the small screw 5 is not attached to the magnetic member 18 totally to result in that the small screw 5 is oblique. It is not convenient for use.

3. The slide sleeve 13 is a cylindrical sleeve, which cannot be replaced arbitrarily and is only applied to the full-size connecting rod 10.

In view of this, it is necessary to lower the cost and make the positioning structure of the screwdriver bit being manufactured easily and used conveniently. Accordingly, the inventor of the present invention has devoted himself based on his many years of practical experiences to solve these problems.

### SUMMARY OF THE PRESENT INVENTION

The primary object of the present invention is to provide a screwdriver bit positioning structure. The screwdriver bit positioning structure comprises a positioning sleeve having a hook portion which is adapted to engage with a screwdriver bit and able to slide on a slide section so as to adjust the engagement position relative to a screw. The hook portion is formed with split grooves, so that the hook portion is elastic and deformable. The present invention can be applied to different connecting rods, decreases the number of parts, and reduces the cost.

### BRIEF DESCRIPTION OF THE DRAWINGS

FIG. 1 is a sectional view of a conventional connecting rod;

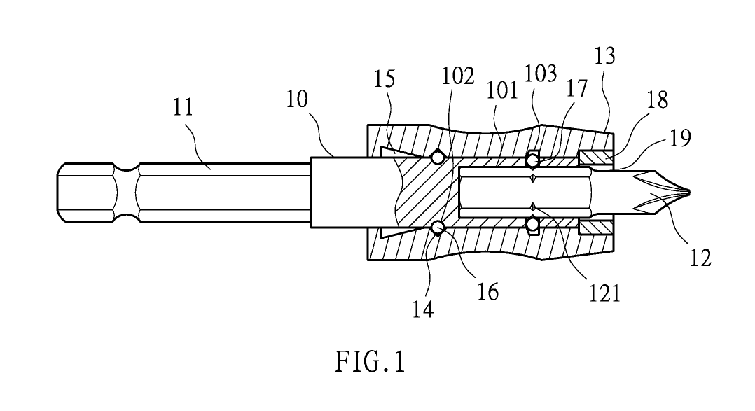

FIG. 2 is a sectional view showing the conventional connecting rod to attract a screw;

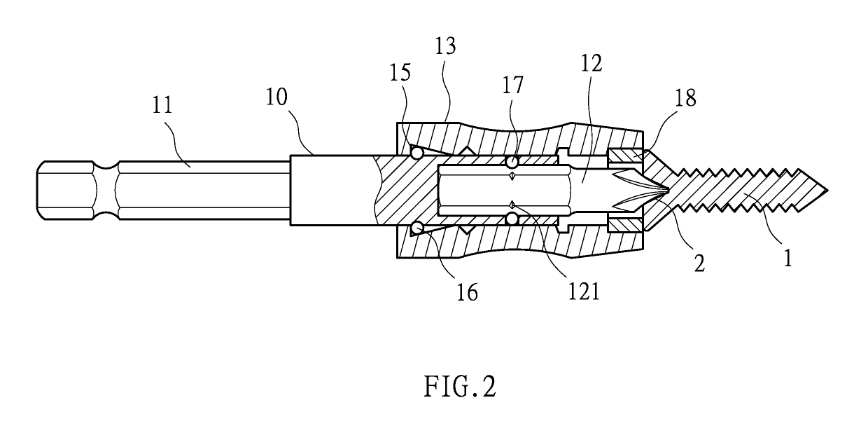

FIG. 3 is a sectional view showing the conventional connecting rod to attract a big small screw, not engaged fully;

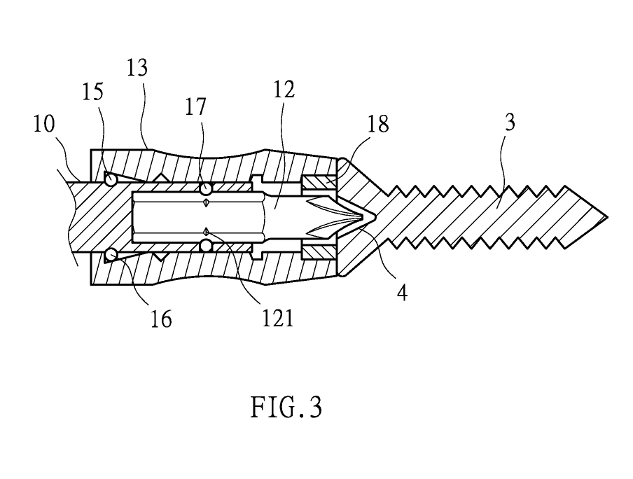

FIG. 4 is a sectional view showing the conventional connecting rod to attract a small screw in an oblique state;

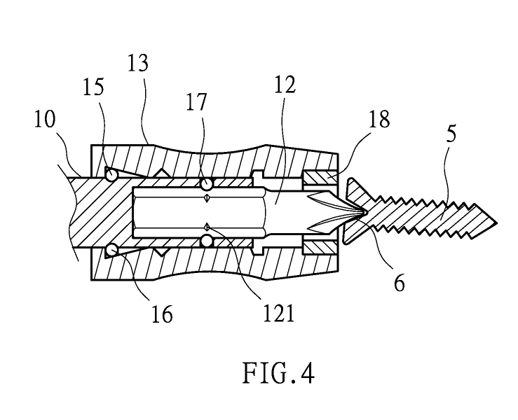

FIG. 5 is an exploded view of the present invention;

FIG. 6 is a perspective view of the present invention;

FIG. 7 is a schematic view of the present invention showing that the hook portion is elastically expanded;

FIG. 8 is a schematic view showing the present invention to attract a big screw; and

FIG. 9 is a schematic view showing the present invention to attract a small screw.

### DETAILED DESCRIPTION OF THE PREFERRED EMBODIMENT

Embodiments of the present invention will now be described, by way of example only, with reference to the accompanying drawings.

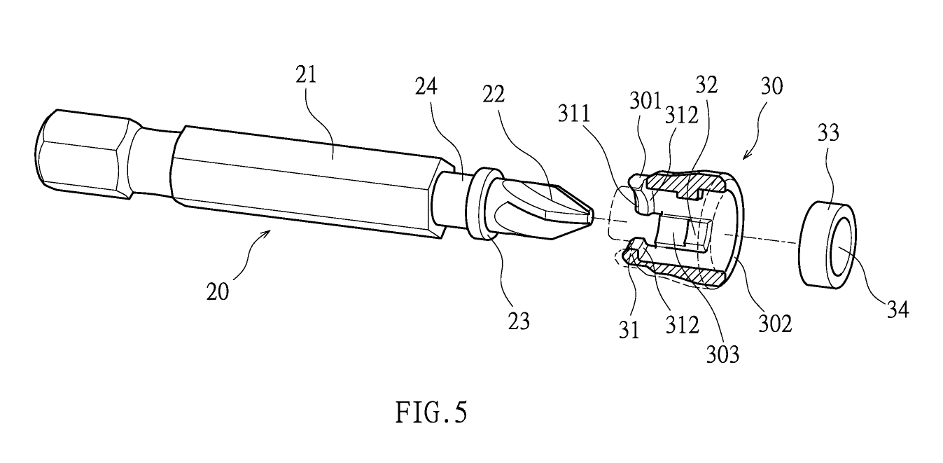

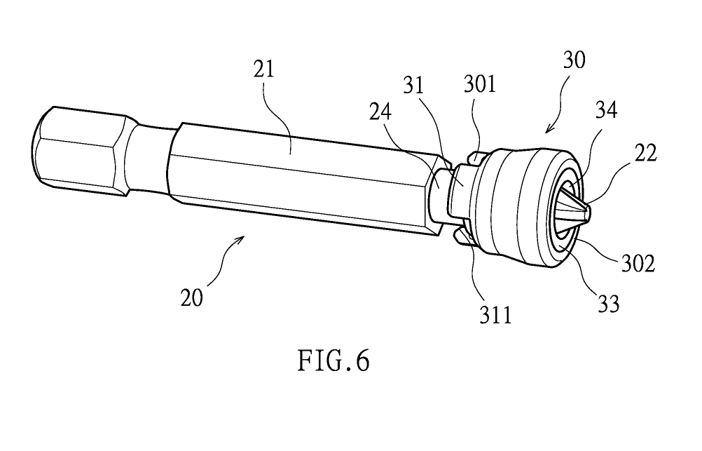

Referring to FIG. 5 through FIG. 7, the present invention discloses a screwdriver bit positioning structure. The screwdriver bit positioning structure comprises a connecting rod 20. One end of the connecting rod 20 is a drive end 21, and another end of the connecting rod 20 is a screwdriver bit 22. A front end of the screwdriver bit 22 is provided with a positioning sleeve 30. The screwdriver bit 22 is provided with a limit ring 23 and a slide section 24 formed between the limit ring 23 and the drive end 21. The positioning sleeve 30 is a hollow sleeve. One end of the positioning sleeve 30 is provided with a hook portion 31 which is adapted to engage with the limit ring 23 and able to slide on the slide section 24. The positioning sleeve 30 is provided with at least two split grooves 301 to form the elastic and deformable claw-like hook portion 31. The hook portion 31 has an outer oblique surface 311 at an outer side thereof and an inner oblique surface 312 at an inner side thereof. Another end of the positioning sleeve 30 is provided with a magnetic member 33 having a through hole 34. An inner wall of the positioning sleeve 30 is formed with a protruding portion 32. The protruding portion 32 includes at least three protrusions which are spaced and arranged annularly. A slide trough 303 is formed between one end of the protruding portion 32 and the hook portion 31. Another end of the protruding portion 32 is adapted to hold against the magnetic member 33. The screwdriver bit 22 is inserted through the positioning sleeve 30 and the through hole 34. The hook portion 31 is slidable on the slide section 24. The screwdriver bit 22 is exposed out of the positioning sleeve 30. According to the aforesaid structure, the positioning sleeve 30 is movable to adjust its position for attracting different sizes of screws and controlling the depth of screwing the screws. The present invention decreases the number of parts, can be assembled easily, and reduces the cost.

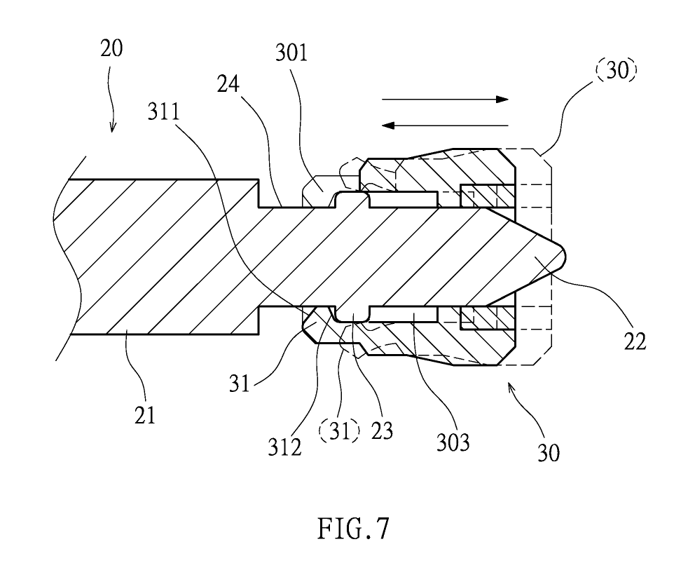

The assembly of the present is described in detail hereinafter. Referring to FIG. 5 to FIG. 7, the positioning sleeve 30 of the present invention is made of a plastic material. The hook portion 31 which is integrally formed with the positioning sleeve 30 is fitted on the screwdriver bit 22. When the hook portion 31 passes over the limit ring 23 having a larger diameter, the outer oblique surface 311 of the hook portion 31 is in contact with the outer edge of the limit ring 23 to press the positioning sleeve 30 so that the hook portion 31 is elastically expanded outward to pass the limit ring 23, as shown in FIG. 7. After passing the limit ring 23, the hook portion 31 is restored for the hook portion 31 to engage with the limit ring 23, such that the positioning sleeve 30 can limit the screwdriver bit 22 and is movable on the slide section 24 to adjust its position. The limit ring 23 is confined within the slide trough 303, such that the positioning sleeve 30 is more stable when it is slid. On the contrary, when the user wants to take out or replace the positioning sleeve 30, the inner oblique surface 312 of the hook portion 31 is in contact with the outer edge of the limit ring 23 and then the hook portion 31 is elastically expanded outward by applying a force to pass the limit ring 23 so that the positioning sleeve 30 can disengage from the screwdriver bit 22. The present invention can be produced easily and has a simple structure. The connecting rod 20 can be replaced with different positioning sleeves 30, and the positioning sleeve 30 can be applied to different connecting rods 20.

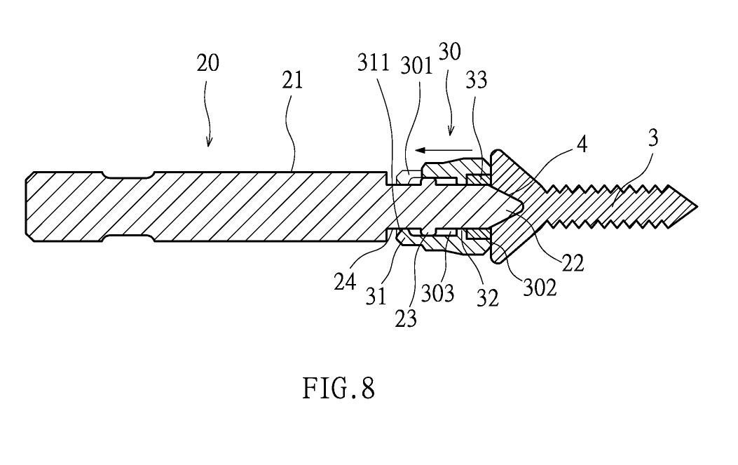

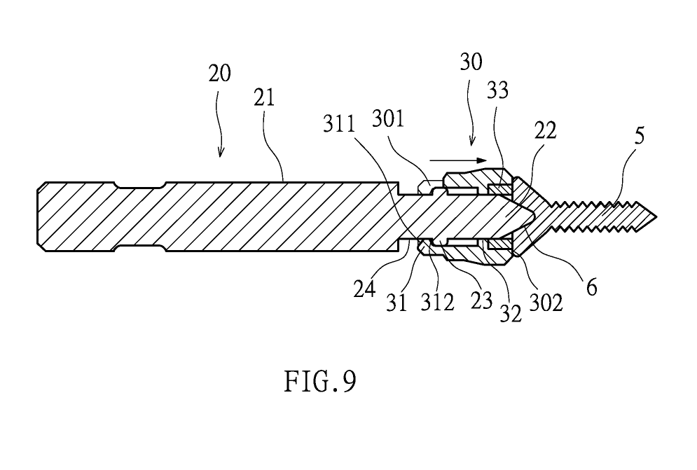

Referring to FIG. 5, FIG. 8 and FIG. 9, when the magnetic member 33 is used to attract a screw, the drive end 21 of the connecting rod 20 is driven by an electric tool so that the screwdriver bit 22 is turned synchronously. When the screw is against a workpiece, the screwdriver bit 22 is inserted to the recess of the screw for the screw to be screwed to the workpiece. When screwing, the end edge 302 of the positioning sleeve 30 will gradually approach the surface of the workpiece. When the end edge 302 of the positioning sleeve 30 is near the surface of the workpiece, the user can know that the screw is locked to an appropriate depth so as to stop screwing. The screw can be locked properly. Referring to FIG. 8, the screws in different sizes have the recesses in different depths. When the magnetic member 33 is used to attract a big screw 3 having a deep recess 4, the positioning sleeve 30 is moved rearward for the screwdriver bit 22 to be exposed longer so as to mate with the recess 4. Referring to FIG. 9, when the magnetic member 33 is used to attract a small screw 5 having a shallow recess 6, the positioning sleeve 30 is moved forward for the positioning sleeve 30 to attract the small screw totally. In such a way, the screwdriver bit 22 extending out of the positioning sleeve 30 is not in a fixed length to influence the magnetic member 33 to attract the small screw 5. Thereby, the positioning sleeve 30 can control the depth of screwing to steady the positioning effect.

It is noted that the hook portion 31 of the positioning sleeve 30 can be used to engage with or disengage from the connecting rod 20 through the property of the plastic material. Thus, the positioning sleeve 30 can be replaced and reused, and are applied to connecting rods 20 in different lengths (such as, 25 mm, 50 mm, 75 mm), and are also applied to different types of screwdriver bits 22.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A screwdriver bit positioning structure, comprising a connecting rod, one end of the connecting rod being a drive end, another end of the connecting rod being a screwdriver bit, a front end of the screwdriver bit being provided with a positioning sleeve, characterized by:
the screwdriver bit being provided with a limit ring and a slide section formed between the limit ring and the drive end, the positioning sleeve being a hollow sleeve, one end of the positioning sleeve being provided with a hook portion adapted to engage with the limit ring and able to slide on the slide section, the hook portion being formed with at least two split grooves, another end of the positioning sleeve being provided with a magnetic member having a through hole, an inner wall of the positioning sleeve being formed with a protruding portion arranged annularly, a slide trough being formed between one end of the protruding portion and the hook portion, another end of the protruding portion being adapted to hold against the magnetic member, the screwdriver bit being inserted through the positioning sleeve and the through hole of the magnetic member, the hook portion being slidable on the slide section, the screwdriver bit being exposed out of the positioning sleeve.

2. The screwdriver bit positioning structure as claimed in claim 1, wherein the hook portion has an outer oblique surface at an outer side thereof.

3. The screwdriver bit positioning structure as claimed in claim 2, wherein the hook portion has an inner oblique surface at an inner side thereof.

4. The screwdriver bit positioning structure as claimed in claim 1, wherein the positioning sleeve is made of a plastic material.

5. The screwdriver bit positioning structure as claimed in claim 1, wherein the protruding portion includes at least three protrusions.
